(19) United States
(12) Patent Application Publication
(10) Pub. No.: US 2003/0170013 A1
(43) Pub. Date: Sep. 11, 2003

(54) Golf club grip heating apparatus and method of heating golf club grips

(76) Inventors: Richard Patshkowski, Spokane, WA (US); Robert Patshkowski, Spokane, WA (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 10/345,032

(22) Filed: Jan. 14, 2003

Related U.S. Application Data
(60) Provisional application No. 60/362,756, filed on Mar. 7, 2002.

(51) Int. Cl. A61H 33/08; F24H 3/02

(52) U.S. Cl. 392/379

(57) ABSTRACT

A golf club grip heating apparatus includes a housing configured to be mounted to a powered golf cart which can seat at least two occupants. A rotatable fan is received by the housing and is electrically powered from electricity provided by the golf cart. A heat generator is received by the housing downstream of the fan. The fan is in fluid communication with the heat generator to drive air over the heat generator within the housing. At least one air outlet is received on the housing downstream of the heat generator and from which heated air is expelled. At least two heated air conduits are connected with the at least one air outlet. Such are of sufficient length and are configured to extend to respective portions of two golf bags received by the golf cart in addition to the housing when the housing is mounted to the golf cart.

### RELATED PATENT DATA

This patent claims priority to U.S. Provisional Patent Application Serial No. 60/362,756, filed Mar. 7, 2002, entitled “Golf Club Drying/Heating System”, naming Richard Patshkowski and Robert Patshkowski as inventors, the disclosure of which is incorporated by reference.

### TECHNICAL FIELD

This invention relates principally to the heating and/or drying of golf club grips.

### BACKGROUND OF THE INVENTION

Golf is not always played where or when it is warm and dry. In many locations, the climate is such that the significant portion of the golf season might constitute a climate that is cold and/or wet.

When a golfer uses a golf club grip that is wet, it tends to be uncomfortable and slippery, and can adversely affect the golfer's shot and confidence. Likewise when the golf club grip is cold, although not necessarily wet, the grip material tends to be firmer and uncomfortable, which can also affect the golfer's shot and the overall feel of the club in the golfer's grip as the ball is struck.

It would be desirable to improve upon existing methods and structures for heating golf club grips within a golf bag.

### SUMMARY

The invention includes golf club grip heating devices and methods of heating golf club grips. In one implementation, a golf club grip heating apparatus includes a housing configured to be mounted to a powered golf cart which is configured to seat at least two occupants. A rotatable fan is received by the housing and configured to be electrically powered from electricity provided by the golf cart. A heat generator is received by the housing downstream of the fan. The fan is in fluid communication with the heat generator to drive air over the heat generator within the housing. At least one air outlet is received on the housing downstream of the heat generator and from which heated air is expelled from the housing. At least two heated air conduits are connected with the at least one air outlet. The two heated air conduits are of sufficient length and are configured to extend to respective portions of two golf bags received by the golf cart in addition to the housing when the housing is mounted to the golf cart.

In one implementation, a method of heating golf club grips includes providing a golf grip heating apparatus on a powered golf cart which is configured to seat at least two occupants. The golf grip heating apparatus has a rotatable fan received by a housing and is configured to be electrically powered from electricity provided by the golf cart. A heat generator is received by the housing downstream of the fan. The fan is in fluid communication with the heat generator to drive air over the heat generator within the housing. At least one air outlet is on the housing downstream of the heat generator and from which heated air is expelled from the housing. Air is driven by the fan over the heat generator effective to increase the temperature of the air. The air of increased temperature is directed to an internal portion of at least one golf bag received by the golf cart in addition to the housing for a time period effective to heat grips of golf clubs received by the golf bag. The housing of the golf grip heating apparatus is separate from the golf bag.

Other aspects and implementations are contemplated.

### BRIEF DESCRIPTION OF THE DRAWINGS

Preferred embodiments of the invention are described below with reference to the following accompanying drawings.

FIG. 1 is a diagrammatic perspective view of a golf cart incorporating an exemplary golf club grip heating apparatus in accordance with an aspect of the invention.

FIG. 2 is an enlarged diagrammatic side view of the golf club grip heating apparatus of FIG. 1.

FIG. 3 is an enlarged diagrammatic top view of the golf club grip heating apparatus of FIG. 1.

FIG. 4 is a diagrammatic sectional view of the FIG. 1 golf club grip heating apparatus.

FIG. 5 is a diagrammatic sectional view of an exemplary alternate embodiment golf club grip heating apparatus in accordance with an aspect of the invention.

FIG. 6 is a diagrammatic sectional view of another exemplary alternate embodiment golf club grip heating apparatus in accordance with an aspect of the invention.

FIG. 7 is a enlarged diagrammatic side view of another implementation of a golf club grip heating apparatus in accordance with an aspect of the invention.

FIG. 8 is a diagrammatic perspective view of a golf cart incorporating the exemplary golf club grip heating apparatus of FIG. 6.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

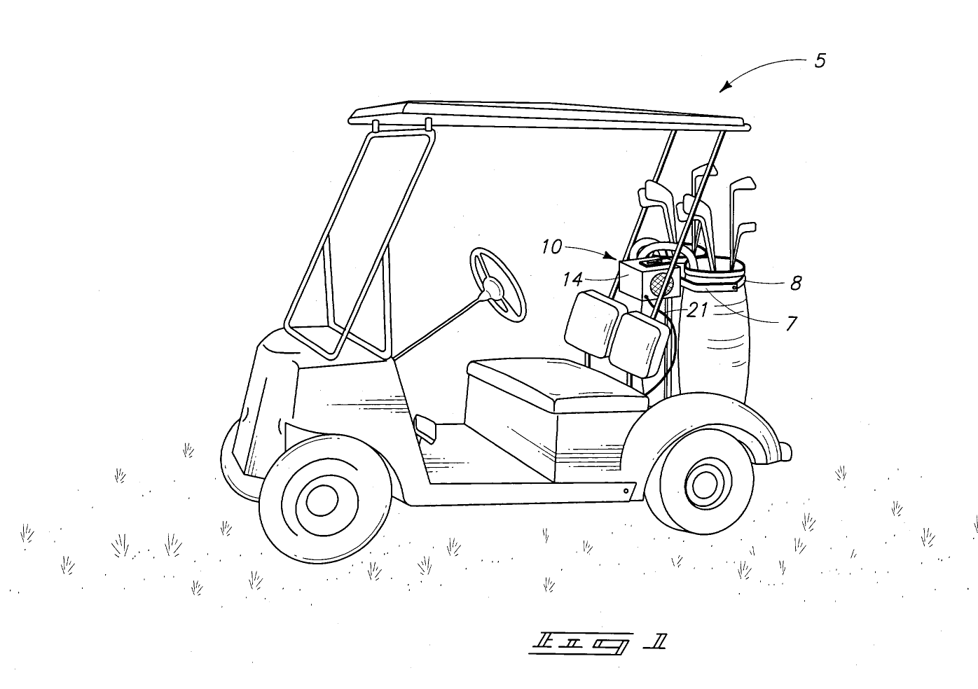

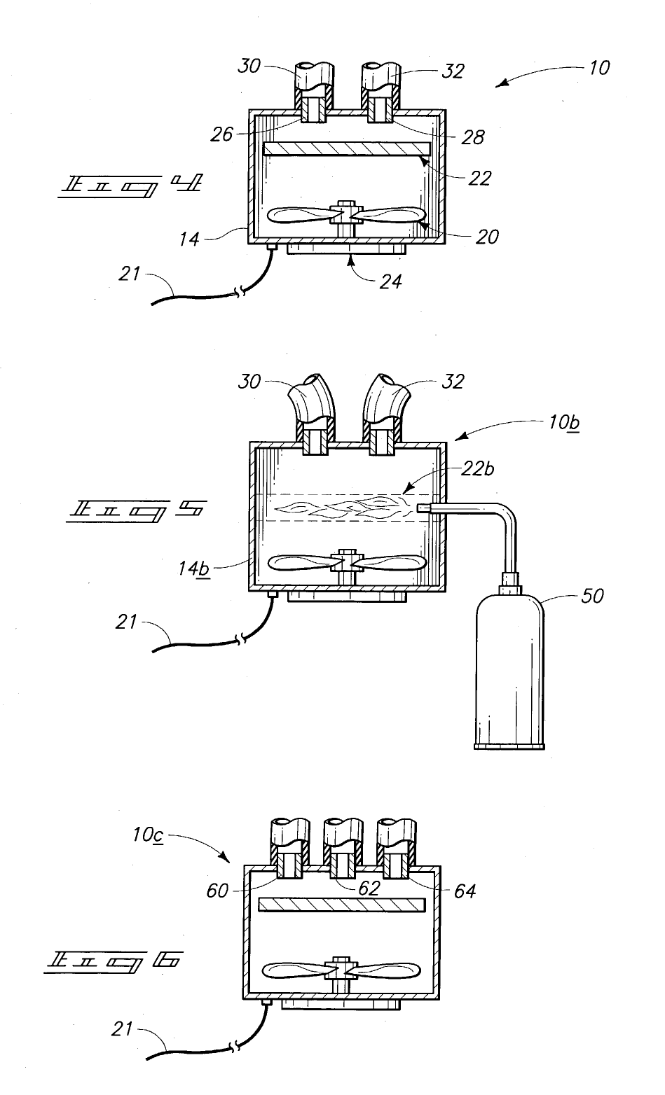

A first preferred embodiment golf club grip heating apparatus is described initially with reference to FIGS. 1-4. Therein, a preferred embodiment golf grip heating apparatus is indicated generally with reference numeral 10. Such includes a housing 14 which is configured to be mounted to a powered golf cart configured to seat at least two occupants. FIG. 1 merely diagrammatically depicts such an exemplary golf cart 5. Of course, any existing or yet-to-be developed golf cart is contemplated. Exemplary golf cart 5 includes a cross-piece 7 having a pair of straps 8 for securing a pair of golf bags 9 and 11 to the cart. Housing 14 of golf club grip heating apparatus 10 is shown mounted to cross-piece 7. Such mounting is illustrated to be by a generally U-shaped bracket 16 which is secured to cross-piece 7 by a nut and bolt assembly 18. A locking/securing bolt 19 is received by housing 14 for holding apparatus 10 relative to bracket 16. Alternately, housing 14 might be configured to mount golf cart 5 anywhere else to cart 5 and in any other manner, with the exemplary embodiment being but one preferred way. Further, the mounting could be in a relatively permanent manner or in an easily removable manner as shown.

A rotatable fan 20 and a heat generator 22 are received by housing 14. In the illustrated and preferred embodiment, the heat generator and fan are received at least partially internally within the housing, and more preferably fully within the housing as shown. Rotatable fan 20 is configured to be electrically powered from electricity powered from electricity provided by the golf cart. An exemplary power line 21 is shown for such purpose. Housing 14 includes an inlet 24 for drawing air therewithin by rotatable fan 20. Heat generator 22 is received by the housing downstream of fan 20, with fan 20 being in fluid communication with heat generator 22 to drive air over heat generator 22 within housing 14.

At least one air outlet is provided on the housing downstream of the heat generator and from which heated air is expelled from the housing. In the illustrated exemplary preferred embodiment, two heated outlets 26 and 28 are shown associated with housing 14. At least two heated air conduits are connected with the at least one air outlet from housing 14. In the depicted and preferred embodiment, a first heated air conduit 30 connects with air outlet 26, and a second heated air conduit 32 connects with air outlet 28. Any alternate configurations are of course contemplated. For example, a single air outlet from housing 14 might split into two or more outlets to which heated air conduits connect. Further, the two heated air conduits might have a single inlet connection and then “y” or otherwise split into two of more flow paths. Further alternately by way of example only, more than two outlets and/or more than two heated air conduits might be associated with housing 14. Regardless, at least two of the heated air conduits are of sufficient length and configured to extend to respective portions of two golf bags received by the golf cart in addition to the housing when the housing is mounted to the golf cart.

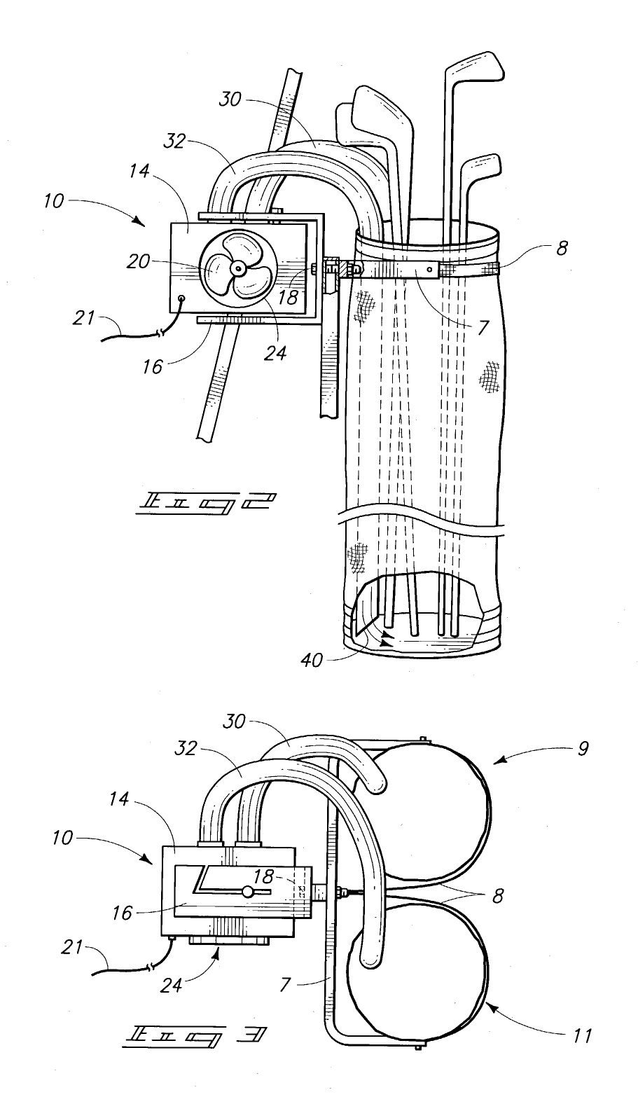

FIGS. 1-3 show the two heated air conduits 30 and 32 to be of sufficient length to extend to proximate respective bottom halves of golf bags 9 and 11 from the tops of such golf bags as received by golf cart 5. Further most preferably as shown, heated air conduits 30 and 32 are of sufficient length to extend to the respective internal floors of the two golf bags, from the golf bag tops, as shown. FIG. 2 further depicts the preferred embodiment conduits 30/32 having heated air emission ends 40 which are angled upstream and configured to bear against the respective internal floors of the golf bags, thereby providing ease of egress of the air from the conduits. Alternately by way of example only and less preferred, the air emission ends of conduits 30 and 32 might terminate away/displaced from the golf bag floors. However, it is most desired for the configuration as shown to emit the heated air from the conduits most proximate the lowest portions of the golf grips received by the golf bags. Preferably and by way of example only, the conduits can be fabricated of a flexible material which connect with rigid pieces (i.e., PVC pipe) that form ends 40.

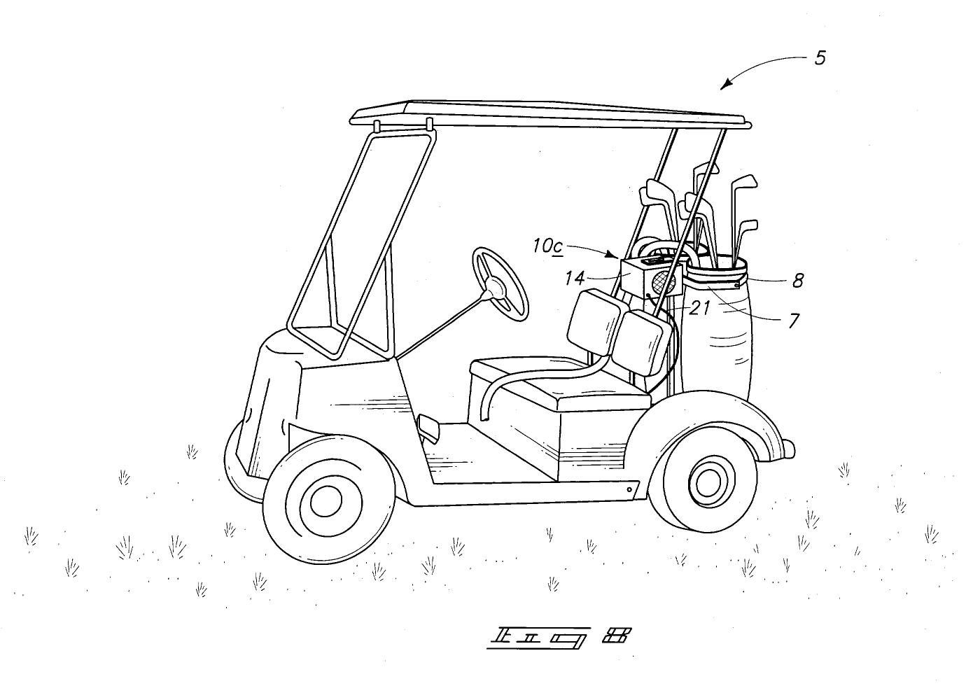

FIG. 7 depicts an alternate implementation. Like numerals from the first embodiment are utilized where appropriate, with differences indicated by the suffix “a” or with different numerals. FIG. 7 depicts a golf bag 11a having been modified or configured to have an air inlet 13 provided at its lowermost portion for connecting one of conduits 30 and 32 thereto. In this manner, the conduit does not extend into the bag from the open bag top. Regardless, if dividers for the golf clubs are provided in the bag, openings therein might also be provided with any of the embodiments to facilitate the flow of heated air to all of the golf club grips contained in the bag.

Today, golf carts are powered either electrically by a plurality of batteries, or by a suitable internal combustion engine. Regardless of which, or if carts are developed to be powered by other means in the future, the rotatable fan with the apparatus as-received by a golf cart is configured to be powered by electricity provided by the golf cart. In one embodiment for example, where the golf cart is electrically driven by one or more batteries, the rotatable fan is configured to be powered by one or more of those same batteries, and in the most preferred embodiment at the same voltage of the batteries which propel the cart. For example, typical electrically powered golf carts today are powered by 48 volt batteries, and in such instances most preferably fan 20 will be powered at 48 volts also. If the golf cart is powered by an internal combustion engine, the rotatable fan can be configured to be electrically powered by a current generating device on the golf cart which is mechanically driven by the internal combustion engine. For example, gas powered golf carts are typically electrically started, and an alternator or generator is associated with the engine to charge the start battery while the engine is running. The rotatable fan is such instance could preferably be configured to be part of that circuit such that it can be electrically powered by the cart batteries when the engine is off and by the current generating device on the golf cart when the engine is running.

Heat generator 22 and rotatable fan 20 might be powered by the same or different primary energy sources. Further, heat generator 22 might be powered primarily non-electrically. In one preferred embodiment, the heat generator comprises an electrically powered heating element which is most preferably powered by electricity provided by the golf cart. For an electrically driven golf cart, heat generator 22 is typically and preferably electrically powered by the cart batteries.

In a specific reduction-to-practice example, housing 14 was configured of sheet metal and had an air inlet of about 4 inches in diameter. Heated air outlets 26 and 28 were approximately 1.5 inches in inner diameter. An electric heating element 22 was utilized which had an output rating of 5500 BTUs, and the fan utilized was rated at 38.9 cubic feet/minute of air-moving capacity. The heat generator was configured/safetied to turn off at 140° Fahrenheit, thereby preventing an overheating situation. Such an apparatus as just described, when operating with both the heat generator and fan energized, drew 14 amps at 48 volts. Such was able to produce a heated air outlet at the bottom of the bag anywhere from 100° Fahrenheit to 120° Fahrenheit with an outside air temperature in the 40's. The drying capability of such an exemplary system was tested by immersing the golf grips of several clubs into a bucket of water and immediately thereafter placing them into a golf bag in their normal manner. The grips were found to be hot and dry to the touch within 15 minutes of being placed within the golf bag when heated by the above apparatus.

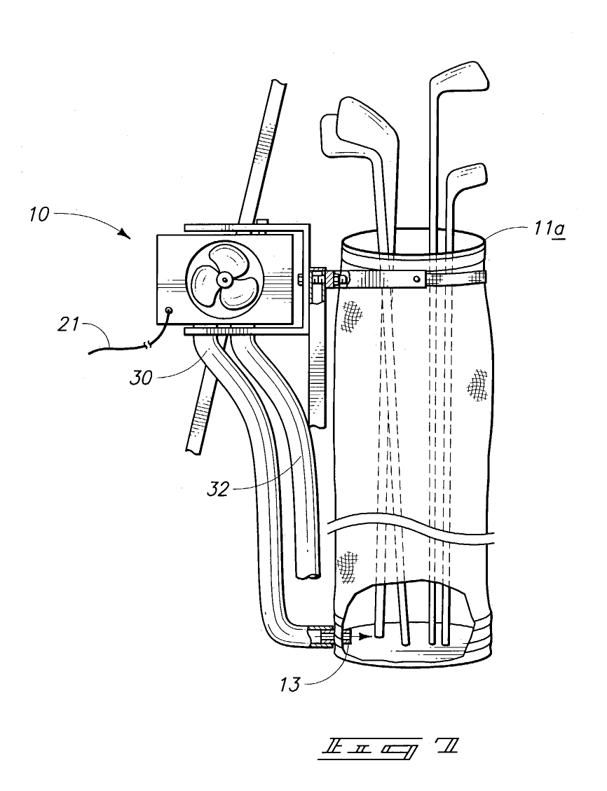

The heat generator might be configured to be powered non-electrically, for example by a propane or other flammable fluid source. FIG. 5 diagrammatically depicts such an alternate exemplary embodiment 10b. Like numerals from first described embodiment are utilized where appropriate, with differences being indicated with the suffix “b” or with different numerals. Diagrammatically, and by way of example only, heat generator 22b is shown received within housing 14 and is capable of suitable flame generation therewithin. A flammable gas or liquid source 50 is shown associated with the apparatus for generating heat within housing 14b, and would preferably be received suitably by/mounted to cart 5.

Of course in any embodiment, suitable electrical switching might be provided for selectively controlling the on/off status of one or both of the heat generator and fan. A control for varying temperature output might also be provided.

FIG. 6 depicts an alternate exemplary embodiment golf grip heating apparatus 10c. Like numerals from first described embodiment are utilized where appropriate, with differences being indicated with the suffix “c” or with different numerals. FIG. 6 depicts golf grip heating apparatus 10c being the same as the first described embodiment but having three heated air outlets 60, 62 and 64. Of course, more outlets might be provided. Heated air conduits would be connected with each of the air outlets, with two of such conduits being intended to extend to the golf bags received by the cart for heating the grips received by the golf bags, and the third conduit being configured to, and being of sufficient length to, extend to proximate an occupant seated in the golf cart. By way of example only, such is shown in FIG. 8. Accordingly, such a conduit could be utilized to heat or dry golf equipment, such as gloves, towels, etc., or simply for heating the golfer. Of course, with any of the above embodiments, if there were only one golfer on the cart, the second and/or third extra heated air conduit could be provided to proximate the golfer for the same or other purposes.

The invention also contemplates a method of heating golf club grips using a provided golf grip heating apparatus on a powered golf cart which is configured to seat at least two occupants. Exemplary and preferred golf grip heating apparatuses are those as described above. Further in methodical aspects of the invention, the golf grip heating apparatus need only comprise at least one air outlet on the housing downstream of the heat generator and from which heated air is expelled from the housing and regardless of multiple heated air conduits. Air is driven with the fan over the heat generator effective to increase the temperature of the air. The air of increased temperature is then directed to an internal portion of at least one golf bag received by the golf cart in addition to the housing for a time period effective to heat the grips of the golf clubs received by the golf bag, and where the housing of the golf grip heating apparatus is separate from the golf bag. Most preferably as described above, the air of increased temperature is directed to portions of at least two golf bags received by the golf cart in addition to the housing for a time period effective to heat the grips of golf clubs received by the respective golf bags, and most preferably directed to the bottom halves of at least two such golf bags. Some of such air of increased temperature might also be directed to proximate a golfer seated in the golf cart.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A golf club grip heating apparatus, comprising:
a housing configured to be mounted to a powered golf cart which is configured to seat at least two occupants;
a rotatable fan received by the housing and configured to be electrically powered from electricity provided by the golf cart;
a heat generator received by the housing downstream of the fan, the fan being in fluid communication with the heat generator to drive air over the heat generator within the housing;
at least one air outlet on the housing downstream of the heat generator and from which heated air is expelled from the housing; and
at least two heated air conduits connected with the at least one air outlet, the two heated air conduits being of sufficient length and configured to extend to respective portions of two golf bags received by the golf cart in addition to the housing when the housing is mounted to the golf cart.

2. The apparatus of claim 1 wherein the apparatus is configured for a golf cart that is electrically driven by one or more batteries, the rotatable fan being configured to be electrically powered by one or more of the batteries which electrically drive the golf cart.

3. The apparatus of claim 1 wherein the apparatus is configured for a golf cart that is electrically driven by a plurality of batteries of the same voltage, the rotatable fan being configured to be electrically powered by one or more of the batteries which electrically drive the golf cart and at the same voltage.

4. The apparatus of claim 1 wherein the apparatus is configured for a golf cart that is powered by an internal combustion engine, the rotatable fan being configured to be electrically powered by a current generating device on the golf cart which is mechanically driven by the internal combustion engine.

5. The apparatus of claim 1 wherein the heat generator comprises an electrically powered heating element.

6. The apparatus of claim 1 wherein the heat generator comprises an electrically powered heating element which is powered by electricity provided by the golf cart.

7. The apparatus of claim 1 wherein the apparatus is configured for a golf cart that is electrically driven by one or more batteries, the heat generator comprising an electrically powered heating element which is powered by one or more of the batteries which electrically drive the golf cart.

8. The apparatus of claim 1 wherein the heat generator and the fan are powered by different primary sources.

9. The apparatus of claim 1 wherein the heat generator and the fan are powered by different primary sources, the heat generator being powered primarily non-electrically.

10. The apparatus of claim 1 wherein the heat generator comprises a flame generator.

11. The apparatus of claim 1 wherein the fan is at least partially received internally within the housing.

12. The apparatus of claim 1 wherein the heat generator is at least partially received internally within the housing.

13. The apparatus of claim 1 comprising at least two air outlets on the housing downstream of the heat generator, one of the outlets connecting with one of the at least two gas conduits, another of the outlets connecting with another of the at least two gas conduits.

14. The apparatus of claim 1 comprising at least three air outlets on the housing downstream of the heat generator.

15. The apparatus of claim 1 comprising a third heated air conduit connected with an air outlet on the housing, the third heated air conduit being of sufficient length to extend to proximate an occupant seated in the golf cart.

16. The apparatus of claim 1 comprising at least three air outlets on the housing downstream of the heat generator, one of the outlets connecting with one of the gas conduits which is extendible to one golf bag on the cart, a second of the outlets connecting with a second of the gas conduits which is extendible to another golf bag on the cart;
and further comprising a third heated air conduit connected with an air outlet on the housing, the third heated air conduit being of sufficient length to extend to proximate an occupant seated in the golf cart, the third heated air conduit connecting with a third of the at least three air outlets on the housing.

17. The apparatus of claim 1 wherein the two heated air conduits are of sufficient length to extend to proximate respective bottom halves of the two golf bags from respective tops of said golf bags.

18. The apparatus of claim 1 wherein the two heated air conduits are of sufficient length to extend to respective internal floors of the two golf bags from respective tops of said golf bags.

19. The apparatus of claim 1 wherein,
the two heated air conduits are of sufficient length to extend to respective internal floors of the two golf bags from respective tops of said golf bags; and
the two heated air conduits have respective heated air emission ends which are angled upstream and configured to bear against said internal floors of the respective golf bags.

20. A golf club grip heating apparatus, comprising:
a housing configured to be mounted to a powered golf cart which is configured to seat at least two occupants;
a rotatable fan received by the housing and configured to be electrically powered from electricity provided by the golf cart, the fan being at least partially received within the housing;
a heat generator received by the housing downstream of the fan and at least partially within the housing, the fan being in fluid communication with the heat generator to drive air over the heat generator within the housing;
at least two air outlets on the housing downstream of the heat generator and from which heated air is expelled from the housing; and
at least two heated air conduits connected with respective of the at least two air outlets, the two heated air conduits being of sufficient length and configured to extend to respective portions of two golf bags received by the golf cart in addition to the housing when the housing is mounted to the golf cart.

21. The apparatus of claim 20 wherein the two heated air conduits are of sufficient length to extend to proximate respective bottom halves of the two golf bags from respective tops of said golf bags.

22. The apparatus of claim 20 wherein the two heated air conduits are of sufficient length to extend to respective internal floors of the two golf bags from respective tops of said golf bags.

23. The apparatus of claim 20 wherein,
the two heated air conduits are of sufficient length to extend to respective internal floors of the two golf bags from respective tops of said golf bags; and
the two heated air conduits have respective heated air emission ends which are angled upstream and configured to bear against said internal floors of the respective golf bags.

24. The apparatus of claim 20 comprising at least three air outlets on the housing downstream of the heat generator.

25. The apparatus of claim 20 comprising a third heated air conduit connected with an air outlet on the housing, the third heated air conduit being of sufficient length to extend to proximate an occupant seated in the golf cart.

26. A method of heating golf club grips comprising:
providing a golf grip heating apparatus on a powered golf cart which is configured to seat at least two occupants, the golf grip heating apparatus comprising a rotatable fan received by a housing and configured to be electrically powered from electricity provided by the golf cart; a heat generator received by the housing downstream of the fan, the fan being in fluid communication with the heat generator to drive air over the heat generator within the housing; at least one air outlet on the housing downstream of the heat generator and from which heated air is expelled from the housing;
driving air with the fan over the heat generator effective to increase temperature of the air; and
directing the air of increased temperature to an internal portion of at least one golf bag received by the golf cart in addition to the housing for a time period effective to heat grips of golf clubs received by the golf bag, the housing of the golf grip heating apparatus being separate from the golf bag.

27. The method of claim 26 directing the air of increased temperature to proximate a golfer seated in the golf cart.

28. The method of claim 26 comprising directing the air of increased temperature to portions of at least two golf bags received by the golf cart in addition to the housing for a time period effective to heat grips of golf clubs received by the respective golf bags.

29. The method of claim 26 comprising directing the air of increased temperature to bottom halves of at least two golf bags received by the golf cart in addition to the housing for a time period effective to heat grips of golf clubs received by the respective golf bags.
